(19) United States
(12) Patent Application Publication
(10) Pub. No.: US 2015/0344739 A1
(43) Pub. Date: Dec. 3, 2015

(54) AQUEOUS DISPERSION FOR CHEMICAL MECHANICAL POLISHING, AND CHEMICAL MECHANICAL POLISHING METHOD

(71) Applicant: JSR CORPORATION, Minato-ku (JP)

(72) Inventors: Yasutaka KAMEI, Minato-ku (JP); Yoshitaka MIYAZAKI, Minato-ku (JP); Tatsuya YAMANAKA, Minato-ku, (JP); Tomohisa KONNO, Minato-ku (JP)

(73) Assignee: JSR CORPORATION, Minato-ku (JP)

(21) Appl. No.: 14/655,575

(22) PCT Filed: Dec. 11, 2013
(86) PCT No.: PCT/JP2013/083242

§ 371 Date: Jun. 25, 2015

(30) Foreign Application Priority Data
Dec. 25, 2012 (JP) 2012-280771

(51) Int. Cl. C09G 1/02

(52) U.S. Cl. CPC C09G 1/02

(57) ABSTRACT

A chemical mechanical polishing aqueous dispersion includes colloidal silica (A), an anionic water-soluble polymer (B), and at least one type of an alkanolamine salt (C) selected from the group consisting of an alkyl sulfate and an alkyl ether sulfate, the chemical mechanical polishing aqueous dispersion having a pH of 1 to 4.

### TECHNICAL FIELD

The present invention relates to a chemical mechanical polishing aqueous dispersion and a chemical mechanical polishing method.

### BACKGROUND ART

In recent years, the dimensions of a wire formed in a semiconductor device have been increasingly reduced along with an increase in the degree of integration of a semiconductor device. A method that planarizes a wiring layer using chemical mechanical polishing (hereinafter may be referred to as “CMP”) has been used in order to deal with such a trend (see JP-T-2002-518845, for example).

For example, planarization using CMP is performed when forming a contact that connects a wiring layer and each section of the device. In this case, a contact hole that connects a gate electrode and a wiring layer is formed in a silicon oxide film. After forming a Ti film/TiN film (adhesive layer) using a sputtering method with high directivity (e.g., long throw sputtering method or collimation sputtering), tungsten (that exhibits an excellent filling capability) is grown (deposited) using a CVD method. The tungsten film formed on the silicon oxide film is then polished by a bulk polishing step using a slurry that can polish tungsten at a very high polishing rate, and a touch-up polishing step (finishing step) is performed in order to eliminate defects on the tungsten film and the silicon oxide film to form a planarized contact. In particular, the touch-up polishing step is required to prevent a situation in which the tungsten plug is corroded, scratches occur on the tungsten plug, and the gate electrode situated under the silicon oxide film is polished. If the gate electrode is damaged by polishing, the semiconductor substrate does not normally function. Therefore, a silicon nitride film (coating) is provided around the gate electrode in order to protect the gate electrode.

Alumina particles have been used as abrasive grains used for a tungsten CMP slurry. In this case, however, a decrease in yield may occur due to electrical connection failure caused by microscratches on the tungsten plug, or insulation failure caused by microscratches on the silicon oxide film, and metal contamination due to inadequate cleaning. In recent years, colloidal silica has been used as abrasive grains in order to prevent the above problem. When using a tungsten CMP slurry that utilizes colloidal silica as abrasive grains, however, colloidal silica may remain on the polishing target surface, and cause a decrease in yield.

### SUMMARY OF INVENTION

### Technical Problem

As described above, the silicon nitride film (coating) is provided around the gate electrode situated under the silicon oxide film in order to prevent a situation in which the gate electrode is polished. Therefore, when implementing the touch-up polishing step, it is necessary to increase the polishing rate of the tungsten film and the silicon oxide film while reducing the polishing rate of the silicon nitride film so that the silicon nitride film can stop the progress of polishing, and protect the gate electrode. A chemical mechanical polishing aqueous dispersion that meets such a demand has not been proposed. It is very difficult to put a chemical mechanical polishing aqueous dispersion to practical use if it is impossible to prevent a decrease in yield due to polishing defects that may occur when colloidal silica remains on the polishing target surface.

Several aspects of the invention may solve the above problem, and provide a chemical mechanical polishing aqueous dispersion that can sufficiently increase the polishing rate of a tungsten film and a silicon oxide film, reduce the polishing rate of a silicon nitride film, and significantly reduce the amount of colloidal silica that remains on the polishing target surface during chemical mechanical polishing.

### Solution to Problem

The invention was conceived in order to achieve the above object, and may be implemented as described below (see the following aspects and application examples).

### Application Example 1

According to one aspect of the invention, a chemical mechanical polishing aqueous dispersion includes colloidal silica (A), an anionic water-soluble polymer (B), and at least one type of an alkanolamine salt (C) selected from the group consisting of an alkyl sulfate and an alkyl ether sulfate, the chemical mechanical polishing aqueous dispersion having a pH of 1 to 4.

### Application Example 2

In the chemical mechanical polishing aqueous dispersion according to Application Example 1, an alkyl sulfate moiety or an alkyl ether sulfate moiety included in the alkanolamine salt (C) may have an alkyl chain having 8 to 20 carbon atoms.

### Application Example 3

In the chemical mechanical polishing aqueous dispersion according to Application Example 1 or 2, the content of the alkanolamine salt (C) may be 0.01 to 0.6 mass %.

### Application Example 4

In the chemical mechanical polishing aqueous dispersion according to any one of Application Examples 1 to 3, the content of the anionic water-soluble polymer (B) may be 0.005 to 0.15 mass %.

### Application Example 5

The chemical mechanical polishing aqueous dispersion according to any one of Application Examples 1 to 4 may be used to polish a polishing target that includes at least a tungsten film and a silicon nitride film.

### Application Example 6

In the chemical mechanical polishing aqueous dispersion according to any one of Application Examples 1 to 5, the polishing rate of the tungsten film may be equal to or more than four times the polishing rate of the silicon nitride film.

### Application Example 7

According to another aspect of the invention, a chemical mechanical polishing method includes using the chemical mechanical polishing aqueous dispersion according to any one of Application Examples 1 to 6.

### Advantageous Effects of Invention

The chemical mechanical polishing aqueous dispersion according to one aspect of the invention can sufficiently increase the polishing rate of a tungsten film and a silicon oxide film, reduce the polishing rate of a silicon nitride film, and significantly reduce the amount of colloidal silica that remains on the polishing target surface during chemical mechanical polishing.

### BRIEF DESCRIPTION OF DRAWINGS

FIG. 1 is a cross-sectional view schematically illustrating a chemical mechanical polishing method according to one embodiment of the invention.

FIG. 2 is a cross-sectional view schematically illustrating a chemical mechanical polishing method according to one embodiment of the invention.

FIG. 3 is a cross-sectional view schematically illustrating a chemical mechanical polishing method according to one embodiment of the invention.

FIG. 4 is a perspective view schematically illustrating a chemical mechanical polishing device.

### DESCRIPTION OF EMBODIMENTS

Exemplary embodiments of the invention are described in detail below. Note that the invention is not limited to the following exemplary embodiments. The invention includes various modifications that may be practiced without departing from the scope of the invention.

### 1. Chemical Mechanical Polishing Aqueous Dispersion

A chemical mechanical polishing aqueous dispersion according to one embodiment of the invention includes colloidal silica (A), an anionic water-soluble polymer (B), and at least one type of an alkanolamine salt (C) selected from the group consisting of an alkyl sulfate and an alkyl ether sulfate, the chemical mechanical polishing aqueous dispersion having a pH of 1 to 4. Each component included in the chemical mechanical polishing aqueous dispersion according to one embodiment of the invention is described in detail below.

### 1.1. Colloidal Silica (A)

The chemical mechanical polishing aqueous dispersion according to one embodiment of the invention includes the colloidal silica (A). The colloidal silica (A) has an effect of mechanically polishing the polishing target film such as a tungsten film, a silicon oxide film, and a silicon nitride film. For example, colloidal silica produced using the method disclosed in JP-A-2003-109921 may be used as the colloidal silica (A). Colloidal silica that has been surface-modified using the method disclosed in JP-A-2010-269985, J. Ind. Eng. Chem., Vol. 12, No. 6, (2006) 911-917, or the like may also be used as the colloidal silica (A).

The average particle size of the colloidal silica (A) is not particularly limited, but is preferably 5 to 100 nm, and more preferably 5 to 80 nm. If the average particle size of the colloidal silica (A) is within the above range, it is possible to produce a stable chemical mechanical polishing aqueous dispersion that can polish a tungsten film at a practical polishing rate, causes scratches to only a small extent, and rarely shows precipitation and separation of particles.

The average particle size of the colloidal silica (A) may be determined by subjecting the chemical mechanical polishing aqueous dispersion according to one embodiment of the invention to particle size distribution analysis using a particle size distribution analyzer that utilizes a dynamic light scattering method as the measurement principle. Examples of the particle size distribution analyzer that utilizes a dynamic light scattering method as the measurement principle include a nanoparticle analyzer “DelsaNano S” manufactured by Beckman Coulter, Inc., “Zetasizer Nano ZS” manufactured by Malvern Instruments Ltd., “LB550” manufactured by Horiba Ltd., and the like. Note that the average particle size measured using a dynamic light scattering method represents the average particle size of secondary particles that are formed by aggregation of a plurality of primary particles.

The content of the colloidal silica (A) in the chemical mechanical polishing aqueous dispersion is preferably 0.05 to 20 mass %, more preferably 0.1 to 15 mass %, and particularly preferably 0.1 to 10 mass %, based on the total mass of the chemical mechanical polishing aqueous dispersion. When the content of the colloidal silica (A) is within the above range, it is possible to produce a stable chemical mechanical polishing aqueous dispersion that can polish a tungsten film and a silicon oxide film at a sufficient polishing rate, and rarely shows precipitation and separation of particles.

### 1.2. Anionic Water-Soluble Polymer (B)

The chemical mechanical polishing aqueous dispersion according to one embodiment of the invention includes the anionic water-soluble polymer (B). The anionic water-soluble polymer (B) is preferentially coordinated to the surface of a silicon nitride film (i.e., part of the polishing target film). It is considered that the anionic water-soluble polymer (B) is preferentially coordinated to the surface of a silicon nitride film due to electrostatic interaction since the surface of a silicon nitride film is normally positively charged. Therefore, the surface of a silicon nitride film is effectively protected, and it is possible to suppress a situation in which the colloidal silica (A) is excessively adsorbed on the surface of a silicon nitride film due to interaction with the silanol group present on the surface of the colloidal silica (A), and the steric hindrance repulsion effect of the anionic water-soluble polymer (B). Therefore, it is possible to easily remove the colloidal silica (A) after polishing by performing a simple cleaning operation.

The anionic water-soluble polymer (B) can include the colloidal silica (A). In this case, the hydrophilicity of the colloidal silica (A) is improved, and it is possible to easily remove the colloidal silica (A) after polishing by performing a simple cleaning operation.

Examples of the anionic group included in the anionic water-soluble polymer (B) include a carboxyl group, a sulfonic acid group, and the like. Examples of the anionic water-soluble polymer that includes a carboxyl group include a (co)polymer of an unsaturated carboxylic acid, carboxymethyl cellulose, salts thereof, and the like. Examples of the anionic water-soluble polymer that includes a sulfonic acid group include a (co)polymer of an unsaturated monomer that includes a sulfonic acid group, and the like.

The (co)polymer of an unsaturated carboxylic acid refers to a homopolymer or a copolymer of an unsaturated carboxylic acid, or a copolymer of an unsaturated carboxylic acid and an additional monomer. Examples of the unsaturated carboxylic acid include acrylic acid, methacrylic acid, crotonic acid, maleic acid, fumaric acid, itaconic acid, and the like. Examples of the additional monomer include (meth)acrylamide, (meth)acrylate, styrene, butadiene, isoprene, and the like. It is preferable that the copolymer of the unsaturated carboxylic acid include a repeating unit derived from the unsaturated carboxylic acid in a ratio of 10 mol % or more (more preferably 30 mol % or more, and still more preferably 50 mol % or more).

The (co)polymer of an unsaturated monomer that includes a sulfonic acid group refers to a homopolymer or a copolymer of an unsaturated monomer that includes a sulfonic acid group, or a copolymer of an unsaturated monomer that includes a sulfonic acid group and an additional monomer. Examples of the unsaturated monomer that includes a sulfonic acid group include styrenesulfonic acid, naphthalenesulfonic acid, isoprenesulfonic acid, and the like. Examples of the additional monomer include (meth)acrylamide, (meth)acrylate, styrene, butadiene, isoprene, and the like. It is preferable that the copolymer of the unsaturated monomer that includes a sulfonic acid group include a repeating unit derived from the unsaturated monomer that includes a sulfonic acid group in a ratio of 10 mol % or more (more preferably 30 mol % or more, and still more preferably 50 mol % or more).

It is preferable to use the (co)polymer of the unsaturated carboxylic acid as the anionic water-soluble polymer (B). It is particularly preferable to use polyacrylic acid or polymethacrylic acid as the anionic water-soluble polymer (B) since the stability of the colloidal silica (A) is not affected. The anionic water-soluble polymer (B) may be an anionic water-soluble polymer in which some or all of the anionic groups are a salt. Examples of a counter cation include an ammonium ion, an alkylammonium ion, a potassium ion, and the like.

Note that the term “(meth)acrylic” used herein refers to both “acrylic” and “methacrylic”.

The weight average molecular weight (Mw) of the anionic water-soluble polymer (B) is preferably 50,000 to 5,000,000, more preferably 200,000 to 5,000,000, and particularly preferably 200,000 to 1,500,000. When the weight average molecular weight of the anionic water-soluble polymer (B) is within the above range, it is possible to increase the polishing rate of a tungsten film and a silicon oxide film while reducing the polishing rate of a silicon nitride film without causing an increase in polishing friction with respect to a silicon nitride film. Note that the weight average molecular weight (Mw) of the anionic water-soluble polymer (B) refers to a polyethylene glycol-equivalent weight average molecular weight (Mw) determined by gel permeation chromatography (GPC).

The content of the anionic water-soluble polymer (B) in the chemical mechanical polishing aqueous dispersion is preferably 0.005 to 0.15 mass %, more preferably 0.008 to 0.10 mass %, and particularly preferably 0.01 to 0.08 mass %, based on the total mass of the chemical mechanical polishing aqueous dispersion. When the content of the anionic water-soluble polymer (B) is within the above range, it is possible to increase the polishing rate of a tungsten film and a silicon oxide film without causing an increase in polishing friction with respect to a silicon nitride film, and easily remove the colloidal silica (A) from the polishing target film after polishing. If the content of the anionic water-soluble polymer (B) exceeds the above range, the polishing rate of a tungsten film and a silicon oxide film tends to decrease, and it may be difficult to selectively polish a tungsten film and a silicon oxide film. If the content of the anionic water-soluble polymer (B) is less than the above range, the amount of the anionic water-soluble polymer (B) may be insufficient to include the colloidal silica (A), and the colloidal silica (A) may remain on the polishing target film.

### 1.3. Alkanolamine Salt (C) of Alkyl(Ether)Sulfate

The chemical mechanical polishing aqueous dispersion according to one embodiment of the invention includes at least one type of the alkanolamine salt (C) selected from the group consisting of an alkyl sulfate and an alkyl ether sulfate (hereinafter may be referred to as “alkanolamine salt (C) of an alkyl (ether) sulfate”). The alkanolamine salt (C) of an alkyl (ether) sulfate has an effect of reducing the polishing rate of a silicon nitride film (i.e., part of the polishing target film). It is considered that the alkanolamine salt (C) of an alkyl (ether) sulfate is adsorbed on the surface of a silicon nitride film to effectively protect the surface of the silicon nitride film, so that the mechanical polishing force applied by the colloidal silica (A) is reduced, and a chemical reaction due to other components is suppressed.

It is preferable that the alkyl sulfate be an alkyl sulfate that has an alkyl chain having 8 to 20 carbon atoms, and more preferably an alkyl sulfate that has an alkyl chain having 10 to 18 carbon atoms. It is particularly preferable that the alkyl sulfate be an alkyl sulfate that has an alkyl chain having 12 to 14 carbon atoms.

It is preferable that the alkyl ether sulfate be a polyoxyethylene alkyl ether sulfate. It is preferable that the polyoxyethylene alkyl ether sulfate have an alkyl chain having 8 to 20 carbon atoms, more preferably an alkyl chain having 10 to 18 carbon atoms, and particularly preferably an alkyl chain having 12 to 14 carbon atoms. It is preferable that the average number of moles of ethylene oxide added to the polyoxyethylene alkyl ether sulfate be 0.5 to 10 mol.

Examples of the alkanolamine that serves as a counter cation with respect to the alkyl (ether) sulfate include monomethanolamine, dimethanolamine, trimethanolamine, monoethanolamine, diethanolamine, triethanolamine, mono(n-propanol)amine, di(n-propanol)amine, tri(n-propanol)amine, monoisopropanolamine, diisopropanolamine, triisopropanolamine, monobutanolamine (including all of the isomers; hereinafter the same), dibutanolamine, tributanolamine, monopentanolamine, dipentanolamine, tripentanolamine, monohexanolamine, dihexanolamine, monoheptanolamine, diheptanolamine, monooctanolamine, monononanolamine, mono decanolamine, monoundecanolamine, monododecanolamine, monotridecanolamine, monotetradecanolamine, monopentadecanolamine, monohexadecanolamine, diethylmonoethanolamine, diethylmonopropanolamine, diethylmonobutanolamine, diethylmonopentanolamine, dipropylmonoethanolamine, dipropylmonopropanolamine, dipropylmonobutanolamine, dipropylmonopentanolamine, dibutylmonoethanolamine, dibutylmonopropanolamine, dibutylmonobutanolamine, dibutylmonopentanolamine, monoethyldiethanolamine, monoethyldipropanolamine, monoethyldibutanolamine, monoethyldipentanolamine, monopropyldiethanolamine, monopropyldipropanolamine, monopropyldibutanolamine, monopropyldipentanolamine, monobutyldiethanolamine, monobutyldipropanolamine, monobutyldibutanolamine, monobutyldipentanolamine, and the like.

Among these, triethanolamine is preferable since it is possible to effectively reduce the polishing rate of a silicon nitride film.

The content of the alkanolamine salt (C) of an alkyl (ether) sulfate in the chemical mechanical polishing aqueous dispersion is preferably 0.01 to 0.6 mass %, more preferably 0.03 to 0.5 mass %, and particularly preferably 0.05 to 0.4 mass %, based on the total mass of the chemical mechanical polishing aqueous dispersion. When the content of the alkanolamine salt (C) of an alkyl (ether) sulfate is within the above range, the alkanolamine salt (C) of an alkyl (ether) sulfate is sufficiently coordinated to the surface of a silicon nitride film, and it is possible to increase the polishing rate of a tungsten film and a silicon oxide film while reducing the polishing rate of a silicon nitride film. If the content of the alkanolamine salt (C) of an alkyl(ether) sulfate exceeds the above range, the polishing rate of a tungsten film tends to decrease, and it may be difficult to selectively polish a tungsten film. If the content of the alkanolamine salt (C) of an alkyl (ether) sulfate is less than the above range, the alkanolamine salt (C) of an alkyl (ether) sulfate may not be sufficiently coordinated to the surface of a silicon nitride film, and it may be difficult to selectively polish a tungsten film.

### 1.4. Additives

The chemical mechanical polishing aqueous dispersion according to one embodiment of the invention may optionally include various additives in addition to the components (A) to (C). Examples of the additives include an oxidizing agent, a pH-adjusting agent, and the like.

### 1.4.1. Oxidizing Agent

The chemical mechanical polishing aqueous dispersion according to one embodiment of the invention may include an oxidizing agent. The oxidizing agent oxidizes the surface of a tungsten film to form a brittle modified layer on the surface of the tungsten film, and allows the tungsten film to be easily polished.

Examples of the oxidizing agent include hydrogen peroxide, an organic peroxide such as peracetic acid, perbenzoic acid, and tert-butyl hydroperoxide, a permanganic acid compound such as potassium permanganate, a dichromic acid compound such as potassium dichromate, a halogen acid compound such as potassium iodate, a nitric acid compound such as nitric acid and iron nitrate, a perhalogen acid compound such as perchloric acid, a persulfate such as ammonium persulfate, a heteropolyacid, and the like. Among these, hydrogen peroxide, an organic peroxide, and a persulfate such as ammonium persulfate are preferable from the viewpoint of oxidizing power, resin substrate corrosiveness, handling capability, and the like, and hydrogen peroxide is particularly preferable since the decomposition product thereof is harmless.

The content of the oxidizing agent in the chemical mechanical polishing aqueous dispersion is preferably 0.5 to 5 mass %, more preferably 1 to 4 mass %, and particularly preferably 1.5 to 3 mass %, based on the total mass of the chemical mechanical polishing aqueous dispersion.

1.4.2. pH of Chemical Mechanical Polishing Aqueous Dispersion and pH-Adjusting Agent

The pH of the chemical mechanical polishing aqueous dispersion according to one embodiment of the invention is 1 to 4, preferably 1.5 to 3.5, and more preferably 2 to 3. When the pH of the chemical mechanical polishing aqueous dispersion is within the above range, it is possible to increase the polishing rate of a tungsten film and a silicon oxide film while reducing the polishing rate of a silicon nitride film. If the pH of the chemical mechanical polishing aqueous dispersion is outside the above range, the polishing rate of a tungsten film may decrease, and it may be difficult to selectively polish a tungsten film.

The pH of the chemical mechanical polishing aqueous dispersion may be adjusted to a value within the above range using an inorganic acid (e.g., hydrochloric acid, nitric acid, sulfuric acid, or phosphoric acid), an organic acid (e.g., maleic acid, malonic acid, tartaric acid, oxalic acid, or citric acid), a strong alkali (e.g., potassium hydroxide, ammonia, or tetramethylammonium hydroxide), or the like.

### 1.5. Selectivity Ratio

It is preferable that the chemical mechanical polishing aqueous dispersion according to one embodiment of the invention achieve a selectivity ratio (polishing rate of tungsten film/polishing rate of silicon nitride film) of 4 or more, and more preferably 6 or more, when a tungsten film and a silicon nitride film are polished using the chemical mechanical polishing aqueous dispersion according to one embodiment of the invention under identical conditions. When the selectivity ratio is within the above range, it is possible to reduce the polishing rate of a silicon nitride film, and selectively polish a tungsten film (i.e., the object of the invention).

### 2. Chemical Mechanical Polishing Method

The chemical mechanical polishing aqueous dispersion may suitably be used for a touch-up polishing step. Specifically, the chemical mechanical polishing aqueous dispersion may suitably be used for a touch-up polishing step that is performed on a polishing target that includes a silicon oxide film that has a contact hole that connects a gate electrode and a wiring layer, and a tungsten film that is provided on the silicon oxide film through a barrier metal film, the gate electrode being coated with a silicon nitride film.

A chemical mechanical polishing method according to one embodiment of the invention is described in detail below with reference to the drawings.

### 2.1. Polishing Target

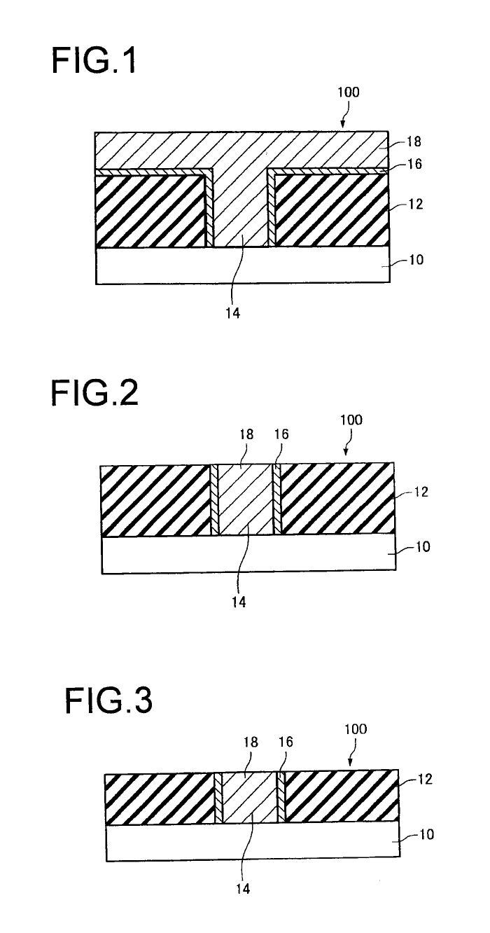

FIG. 1 illustrates a polishing target that is applied to the chemical mechanical polishing method according to one embodiment of the invention.

(1) As illustrated in FIG. 1, a substrate 10 is provided. The substrate 10 may include a silicon substrate, and a silicon oxide film that is formed on the silicon substrate, for example. A functional device (not illustrated in FIG. 1) such as a field-effect transistor (FET) that includes a source electrode, a drain electrode, and a gate electrode, is formed on the substrate 10. Note that the gate electrode is coated with a silicon nitride film (not illustrated in FIG. 1) in order to protect the gate electrode. A silicon oxide film 12 (i.e., insulating film) is formed on the substrate 10 using a CVD method or a thermal oxidation method.

(2) A contact hole 14 that connects the gate electrode and a wire is formed in the silicon oxide film 12.

(3) A barrier metal film 16 is formed on the surface of the silicon oxide film 12 and the inner wall surface of the contact hole 14 using a long throw sputtering method or a collimation sputtering method. Since adhesion between tungsten and silicon is not good, excellent adhesion is achieved by providing the barrier metal film. The barrier metal film 16 may be a Ti film and/or TiN film.

(4) A tungsten film 18 is formed using a CVD method.

A polishing target 100 illustrated in FIG. 1 is formed by these steps.

### 2.2. Chemical Mechanical Polishing Method

### 2.2.1. Bulk Polishing Step

A bulk polishing step is performed. In the bulk polishing step, the barrier metal film 16 and the tungsten film 18 are polished using the chemical mechanical polishing aqueous dispersion that can polish tungsten at a high polishing rate until the silicon oxide film 12 is exposed (see FIG. 2).

### 2.2.2. Touch-Up Polishing Step

A touch-up polishing step is then performed. In the touch-up polishing step, the barrier metal film 16, the tungsten film 18, and the silicon oxide film 12 are simultaneously polished using the chemical mechanical polishing aqueous dispersion (see FIG. 3). The touch-up polishing step corresponds to a finishing step. Since the chemical mechanical polishing aqueous dispersion has a capability to non-selectively polish the tungsten film and the silicon oxide film, a polished surface that exhibits excellent flatness can be obtained by the touch-up polishing step.

The chemical mechanical polishing aqueous dispersion used for the touch-up polishing step can polish the tungsten film and the silicon oxide film at a high polishing rate, but polishes the silicon nitride film at a low polishing rate. Therefore, since the silicon nitride film formed around the gate electrode serves as a stopper film even if the silicon oxide film 12 is continuously polished, it is possible to prevent a situation in which the gate electrode is damaged by polishing.

### 2.2.3. Chemical Mechanical Polishing Device

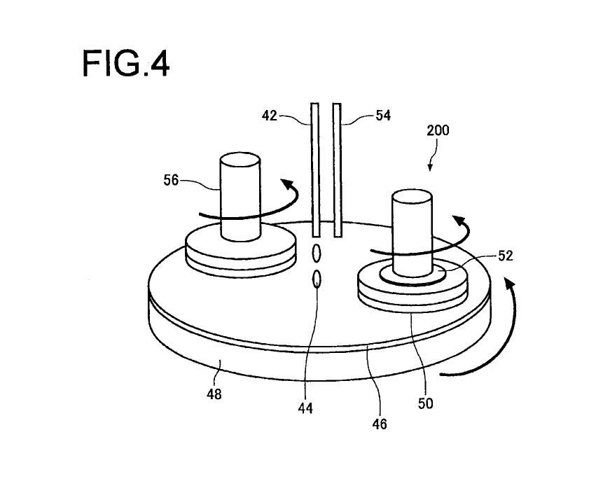

A chemical mechanical polishing device 200 illustrated in FIG. 4 may be used when performing the bulk polishing step and the touch-up polishing step, for example. FIG. 4 is a perspective view schematically illustrating the chemical mechanical polishing device 200. A carrier head 52 that holds a semiconductor substrate 50 is brought into contact with a turntable 48 to which an abrasive cloth 46 is attached while supplying a slurry 44 from a slurry supply nozzle 42, and rotating the turntable 48. FIG. 4 also illustrates a water supply nozzle 54 and a dresser 56.

The polishing load applied by the carrier head 52 may be selected within the range of 1 to 98 kPa, and is preferably 3 to 49 kPa. The rotational speed of the turntable 48 and the carrier head 52 may be appropriately selected within the range of 10 to 400 rpm, and is preferably 30 to 150 rpm. The flow rate of the slurry 44 supplied from the slurry supply nozzle 42 may be selected within the range of 10 to 1000 mL/min, and is preferably 50 to 400 mL/min.

Examples of a commercially available chemical mechanical polishing device include “EPO-112” and “EPO-222” (manufactured by Ebara Corporation); “LGP510” and “LGP552” (manufactured by Lapmaster SFT Corporation); “Mirra” and “Reflexion” (manufactured by Applied Materials, Inc.); and the like.

### 3. Examples

The invention is further described below by way of examples. Note that the invention is not limited to the following examples.

### 3.1. Preparation of Chemical Mechanical Polishing Aqueous Dispersion

### 3.1.1. Preparation of Colloidal Silica Aqueous Dispersion

No. 3 water glass (silica concentration: 24 mass %) was diluted with water to prepare a diluted sodium silicate aqueous solution having a silica concentration of 3.0 mass %. The diluted sodium silicate aqueous solution was passed through a hydrogen cation-exchange resin layer to obtain an active silica aqueous solution (pH: 3.1) from which most of the sodium ions were removed. The pH of the active silica aqueous solution was immediately adjusted to 7.2 by adding a 10 mass % potassium hydroxide aqueous solution with stirring. The mixture was then boiled, and aged for 3 hours. The active silica aqueous solution (pH: 7.2) (10-fold amount) was gradually added to the resulting aqueous solution so that colloidal silica was grown.

The aqueous dispersion including colloidal silica was concentrated under reduced pressure to obtain a colloidal silica aqueous dispersion (silica concentration: 32.0 mass %, pH: 9.8). The colloidal silica aqueous dispersion was passed through the hydrogen cation-exchange resin layer to remove most of the sodium ions. A 10 mass % potassium hydroxide aqueous solution was then added to the dispersion to obtain a colloidal silica aqueous dispersion (silica particle concentration: 28.0 mass %, pH: 10.0).

### 3.1.2. Preparation of Aqueous Solution Including Polyacrylic Acid

500 g of a 20 mass % acrylic acid aqueous solution was evenly added dropwise to a vessel (internal volume: 2 L) charged with 1000 g of ion-exchanged water and 1 g of a 5 mass % ammonium persulfate aqueous solution over 8 hours under reflux at 70° C. with stirring. After the dropwise addition, the mixture was allowed to stand for 2 hours under reflux to obtain an aqueous solution including polyacrylic acid. The polyethylene glycol-equivalent weight average molecular weight (Mw) of the polyacrylic acid determined by gel permeation chromatography (device: “HCL-8120” manufactured by Tosoh Corporation, column: “TSK-GEL alpha-M”, eluant: NaCl aqueous solution/acetonitrile) was 825,000.

### 3.1.3. Preparation of Chemical Mechanical Polishing Aqueous Dispersion

A polyethylene bottle was charged with 50 parts by mass of ion-exchanged water, the colloidal silica aqueous dispersion (2.5 parts by mass on a solid basis), and the aqueous solution including polyacrylic acid (0.05 parts by mass on a polymer basis), followed by the addition of 0.18 parts by mass of triethanolamine lauryl sulfate. After the addition of 1 part by mass of hydrogen peroxide, the mixture was stirred for 15 minutes. After the addition of maleic acid and ion-exchanged water so that the total amount of the components was 100 parts by mass and a predetermined pH was achieved, the mixture was filtered through a filter having a pore size of 5 micrometers to obtain a chemical mechanical polishing aqueous dispersion of Example 1 (see Table 1).

Chemical mechanical polishing aqueous dispersions of Examples 2 to 10 and Comparative Examples 1 to 6 were prepared in the same manner as in Example 1, except that the type and the amount of each component were changed as shown in Table 1.

The average particle size of the colloidal silica included in the chemical mechanical polishing aqueous dispersion of Example 1 measured using a particle size distribution analyzer (that utilizes a dynamic light scattering method as the measurement principle) (“LB550” manufactured by Horiba Ltd.) was 75 nm. The surface charge (zeta potential) of the colloidal silica included in the chemical mechanical polishing aqueous dispersion measured using an ultrasonic particle size distribution-zeta potential analyzer (“DT-1200” manufactured by Dispersion Technology) was −1.5 mV. The surface charge (zeta potential) of the colloidal silica included in each of the chemical mechanical polishing aqueous dispersions of Examples 2 to 10 and Comparative Examples 1 to 6 was measured in the same manner as described above. The results are shown in Table 1.

### 3.2. Evaluation Method

A polishing pad made of porous polyurethane (“IC1000” manufactured by Nitta Haas Inc.) was fitted to a chemical mechanical polishing device (“Reflexion LK” manufactured by AMAT). A polishing rate measurement substrate (see below) was subjected to chemical mechanical polishing under the following polishing conditions while supplying the chemical mechanical polishing aqueous dispersion prepared as described above. The polishing rate and the selectivity ratio were evaluated using the following methods. The results are shown in Table 1.

(1) Polishing Rate Measurement Substrate

Blanket wafer (diameter: 300 mm) provided with tungsten film (“W-Blanket” manufactured by SKW Associates)

Silicon wafer (diameter: 300 mm) provided with silicon nitride film

The silicon wafer provided with a silicon nitride film was bonded to the measurement cell of a zeta potential analyzer (“ELS6000” manufactured by Otsuka Electronics Co., Ltd.), and the zeta potential of the surface of the wafer was measured. Note that the zeta potential of the surface of the wafer was measured using a sample obtained by dissolving the components of the chemical mechanical polishing aqueous dispersion in a 0.01 mol/L sodium chloride aqueous solution in equal amounts, and adding one drop (0.1 g) of the colloidal silica aqueous dispersion to the solution.

(2) Polishing Conditions

Head rotational speed: 91 rpm

Head load: 10.3 kPa (1.5 psi)

Platen rotational speed: 90 rpm

Chemical mechanical polishing aqueous dispersion supply rate: 300 mL/min

(3) Evaluation of Polishing Rate

The thickness of each wafer (diameter: 300 mm) provided with a tungsten film or a silicon nitride film (polishing target) before polishing was measured using a sheet resistance-type metal film thickness meter “RS-100” (manufactured by KLA-Tencor) and an optical interference-type film thickness meter “ASET-F5X” (manufactured by KLA-Tencor). Each wafer was polished for 1 minute under the above conditions. The thickness of each wafer (polishing target) after polishing was measured using the optical interference-type film thickness meter, and the difference between the thickness before polishing and the thickness after polishing (i.e., the thickness reduced by chemical mechanical polishing) was calculated. The polishing rate was calculated from the polishing time and the thickness reduced by chemical mechanical polishing.

A case where the selectivity ratio (polishing rate of tungsten film/polishing rate of silicon nitride film) was 4.0 or more was evaluated as “Good” (see Table 1). A case where the selectivity ratio was less than 4.0 was evaluated as “Bad” (see Table 1) since the selectivity balance was poor.

(4) Evaluation of Defects on Silicon Nitride Film

The total number of defects having a size of 90 nm or more was counted by observing the wafer provided with a silicon nitride film (that had been subjected to evaluation of the polishing rate (see above)) using a defect inspection device (“Surfscan SP1” manufactured by KLA-Tencor). A case where the total number of defects was less than 100 was evaluated as “Good” (see Table 1). A case where the total number of defects was 100 or more was evaluated as “Bad” (see Table 1).

TABLE 1

| | | | Example | | | | | |
|---|---|---|---|---|---|---|---|---|
| | | Component | 1 | 2 | 3 | 4 | 5 | 6 |
| Chemical | Abrasive grain | Colloidal silica (mass %) | 2.5 | 2.5 | 2.5 | 2.5 | 2.0 | 2.5 |
| mechanical | Water-soluble | Polyacrylic acid (mass %) | 0.05 | 0.05 | 0.08 | | 0.01 | 0.03 |
| polishing aqueous | polymer | Polystyrenesulfonic acid (mass %) | | | | 0.05 | | |
| dispersion | | Polyethylene glycol (mass %) | | | 0.05 | | | |
| | Surfactant | Triethanolamine lauryl sulfate (mass %) | 0.18 | 0.10 | 0.40 | 0.18 | 0.05 | 0.18 |
| | | Triethanolamine polyoxyethylene lauryl ether | | | | | | |
| | | sulfate (mass %) | | | | | | |
| | | Ammonium lauryl sulfate (mass %) | | | | | 0.18 | |
| | | Triethanolamine myristyl sulfate (mass %) | | | | | | |
| | | Triethanolamine dodecylbenzenesulfonate | | | | | | 0.18 |
| | | (mass %) | | | | 0.18 | | |
| | | Polyoxyethylene lauryl ether (mass %) | | | | | | |
| | pH-adjusting | Maleic acid (mass %) | 0.06 | 0.06 | 0.08 | 0.06 | 0.06 | |
| | agent | Citric acid (mass %) | | | | | | 0.05 |
| | | Phosphoric acid (mass %) | | | | | | |
| | Oxidizing agent | Hydrogen peroxide (mass %) | 1.0 | 1.0 | 1.0 | 1.0 | 1.5 | 1.0 |
| | pH | | 2.5 | 2.5 | 2.5 | 2.5 | 2.5 | 2.5 |
| Evaluation item | Surface charge (mV) of abrasive grain | | −1.5 | −1.2 | −3.5 | −4.0 | −1.0 | −1.5 |
| | Surface charge (mV) of substrate | | −47 | −40 | −47 | −47 | −30 | −45 |
| | Polishing rate of tungsten film: WRR (angstroms/min) | | 115 | 122 | 100 | 108 | 170 | 117 |
| | Polishing rate of silicon nitride film: SiNRR (angstroms/min) | | 16 | 30 | 16 | 17 | 23 | 19 |
| | Selectivity ratio: WRR/SiNRR | | 7.2 | 4.1 | 6.3 | 6.4 | 7.4 | 6.2 |
| | Evaluation of selectivity ratio: (WRR/SiNRR ≧4 = Good) | | Good | Good | Good | Good | Good | Good |
| | Evaluation of defects on silicon nitride film | | Good | Good | Good | Good | Good | Good |
| | (number of defects <100 = Good) | | | | | | | |
| | | | | | | | Comparative | |
| | | | Example | | | | Example | |
| | | Component | 7 | 8 | 9 | 10 | 1 | 2 |
| Chemical | Abrasive grain | Colloidal silica (mass %) | 2.5 | 0.5 | 2.5 | 2.5 | 2.5 | 2.5 |
| mechanical | Water-soluble | Polyacrylic acid (mass %) | 0.03 | 0.05 | 0.05 | 0.05 | 0.05 | 0.08 |
| polishing aqueous | polymer | Polystyrenesulfonic acid (mass %) | | | | | | |
| dispersion | | Polyethylene glycol (mass %) | | | | | | |
| | Surfactant | Triethanolamine lauryl sulfate (mass %) | 0.18 | 0.10 | 0.40 | 0.40 | 0.18 | |
| | | Triethanolamine polyoxyethylene lauryl ether | | | | 0.18 | | |
| | | sulfate (mass %) | | | | | | |
| | | Ammonium lauryl sulfate (mass %) | | | | | | |
| | | Triethanolamine myristyl sulfate (mass %) | | | 0.05 | | | |
| | | Triethanolamine dodecylbenzenesulfonate | | | | | | |
| | | (mass %) | | | | | | |
| | | Polyoxyethylene lauryl ether (mass %) | | | | | | |
| | pH-adjusting | Maleic acid (mass %) | | | 0.06 | 0.06 | 0.09 | |
| | agent | Citric acid (mass %) | 0.047 | | 0.05 | | | |
| | | Phosphoric acid (mass %) | | 0.05 | | | | |
| | Oxidizing agent | Hydrogen peroxide (mass %) | 1.0 | 1.0 | 1.0 | 1.0 | 1.0 | 1.0 |
| | pH | | 3.0 | 2.1 | 2.5 | 2.5 | 0.8 | 4.5 |

| | | | | | | | |
|---|---|---|---|---|---|---|---|
| Evaluation item | Surface charge (mV) of abrasive grain | −1.5 | −35 | −1.2 | −1.3 | −3.0 | −3.5 |
| | Surface charge (mV) of substrate | −46 | −47 | −40 | −43 | −48 | −47 |
| | Polishing rate of tungsten film: WRR (angstroms/min) | 118 | 180 | 125 | 106 | 57 | 50 |
| | Polishing rate of silicon nitride film: SiNRR (angstroms/min) | 25 | 8 | 15 | 11 | 15 | 30 |
| | Selectivity ratio: WRR/SiNRR | 4.7 | 22.5 | 8.3 | 9.6 | 3.8 | 1.7 |
| | Evaluation of selectivity ratio: (WRR/SiNRR ≧4 = Good) | Good | Good | Good | Good | Bad | Bad |
| | Evaluation of defects on silicon nitride film | Good | Good | Good | Good | Good | Good |
| | (number of defects <100 = Good) | | | | | | |

| | | | Comparative Example | | | |
|---|---|---|---|---|---|---|
| | | Component | 3 | 4 | 5 | 6 |
| Chemical | Abrasive grain | Colloidal silica (mass %) | 2.5 | 3 | 2.5 | 2.5 |
| mechanical | Water-soluble | Polyacrylic acid (mass %) | | 0.05 | 0.05 | 0.05 |
| polishing aqueous | polymer | Polystyrenesulfonic acid (mass %) | | | | |
| dispersion | | Polyethylene glycol (mass %) | | | | |
| | Surfactant | Triethanolamine lauryl sulfate (mass %) | | | | |
| | | Triethanolamine polyoxyethylene lauryl ether | | | | |
| | | sulfate (mass %) | | | | |
| | | Ammonium lauryl sulfate (mass %) | | | | |
| | | Triethanolamine myristyl sulfate (mass %) | | | | |
| | | Triethanolamine dodecylbenzenesulfonate | | | | |
| | | (mass %) | | | | |
| | | Polyoxyethylene lauryl ether (mass %) | | | | |
| | pH-adjusting | Maleic acid (mass %) | 0.06 | 0.06 | 0.06 | 0.06 |
| | agent | Citric acid (mass %) | | | | |
| | | Phosphoric acid (mass %) | | | | |
| | Oxidizing agent | Hydrogen peroxide (mass %) | 1.0 | 1.0 | 1.0 | 1.0 |
| | pH | | 2.5 | 3 | 2.5 | 2.5 |

| | | | | | |
|---|---|---|---|---|---|
| Evaluation item | Surface charge (mV) of abrasive grain | +0.6 | +1.2 | −2.0 | −3.0 |
| | Surface charge (mV) of substrate | −32 | +3.0 | −30 | −36 |
| | Polishing rate of tungsten film: WRR (angstroms/min) | 115 | 52 | 48 | 43 |
| | Polishing rate of silicon nitride film: SiNRR (angstroms/min) | 16 | 20 | 16 | 14 |
| | Selectivity ratio: WRR/SiNRR | 7.2 | 2.6 | 3.0 | 3.1 |
| | Evaluation of selectivity ratio: (WRR/SiNRR ≧4 = Good) | Good | Bad | Bad | Bad |
| | Evaluation of defects on silicon nitride film | Bad | Good | Bad | Good |
| | (number of defects <100 = Good) | | | | |

The details of the components shown in Table 1 are shown below.

Colloidal silica: colloidal silica obtained in “3.1.1. Preparation of colloidal silica aqueous dispersion”

Polyacrylic acid: polyacrylic acid obtained in “3.1.2. Preparation of aqueous dispersion including polyacrylic acid”

Polystyrenesulfonic acid: “PS-5” manufactured by Tosoh Corporation, weight average molecular weight (Mw): 50,000

Polyethylene glycol: “PEG #200” manufactured by NOF Corporation, weight average molecular weight (Mw): 200

Triethanolamine lauryl sulfate: “Emal TD” manufactured by Kao Corporation

Triethanolamine polyoxyethylene lauryl ether sulfate: “Emal 20T” manufactured by Kao Corporation, number of moles of ethylene oxide added: 3

Ammonium lauryl sulfate: “Latemul AD-25” manufactured by Kao Corporation

Triethanolamine myristyl sulfate: “Alscoap LS-40T” manufactured by Toho Chemical Industry Co., Ltd.

Triethanolamine dodecylbenzenesulfonate: a triethanolamine dodecylbenzenesulfonate salt aqueous solution prepared by mixing “Neopelex GS” manufactured by Kao Corporation and “Triethanolamine” manufactured by Nippon Shokubai Co., Ltd. in equal molar equivalents

Polyoxyethylene lauryl ether: “Emulgen 150” manufactured by Kao Corporation

### 3.3. Evaluation Results

When using the chemical mechanical polishing aqueous dispersions of Examples 1 to 10, the selectivity ratio (tungsten film polishing rate/silicon oxide film polishing rate) was 4 or more. The number of defects on the silicon nitride film was less than 100. It was thus confirmed that an excellent polished surface can be obtained using the chemical mechanical polishing aqueous dispersions of Examples 1 to 10.

When using the chemical mechanical polishing aqueous dispersions of Comparative Examples 1 and 2, the polishing rate of the tungsten film decreased, and the selectivity ratio was less than 4 since the pH of the chemical mechanical polishing aqueous dispersion was outside the specific range.

When using the chemical mechanical polishing aqueous dispersions of Comparative Examples 3 to 6 in which the anionic water-soluble polymer (B) and the alkanolamine salt (C) of an alkyl (ether) sulfate were not used in combination, the selectivity ratio was less than 4 and/or the number of defects on the silicon nitride film was 100 or more. It was thus confirmed that it is important to use the anionic water-soluble polymer (B) and the alkanolamine salt (C) of an alkyl (ether) sulfate in combination in order to ensure that the selectivity ratio is 4 or more, and the number of defects on the silicon nitride film is less than 100.

It was thus confirmed that the chemical mechanical polishing aqueous dispersion according to the embodiments of the invention that includes the colloidal silica (A), the anionic water-soluble polymer (B), and the alkanolamine salt (C) of an alkyl (ether) sulfate, and has a pH of 1 to 4 can sufficiently increase the polishing rate of a tungsten film, reduce the polishing rate of a silicon nitride film, and significantly reduce the amount of colloidal silica that remains on the polishing target surface during chemical mechanical polishing.

### REFERENCE SIGNS LIST

10: substrate, 12: silicon oxide film, 14: contact hole, 16: barrier metal film, 18: tungsten film, 42: slurry supplying nozzle, 44: slurry, 46: abrasive cloth, 48: turntable, 50: semiconductor substrate, 52: carrier head, 54: water supply nozzle, 56: dresser, 100: polishing target, 200: chemical mechanical polishing device

1. A chemical mechanical polishing aqueous dispersion, comprising:
colloidal silica (A),
an anionic water-soluble polymer (B), and
at least one an alkanolamine salt (C) selected from a group consisting of an alkyl sulfate and an alkyl ether sulfate,
wherein the chemical mechanical polishing aqueous dispersion has a pH of 1 to 4.

2. The chemical mechanical polishing aqueous dispersion according to claim 1, wherein an alkyl sulfate moiety or an alkyl ether sulfate moiety included in the alkanolamine salt (C) has an alkyl chain having 8 to 20 carbon atoms.

3. The chemical mechanical polishing aqueous dispersion according to claim 1, wherein a content of the alkanolamine salt (C) is 0.01 to 0.6 mass %.

4. The chemical mechanical polishing aqueous dispersion according to claim 1, wherein a content of the anionic water-soluble polymer (B) is 0.005 to 0.15 mass %.

5. A method, comprising polishing with the chemical mechanical polishing aqueous dispersion of claim 1.

6. The method of claim 7, wherein a polishing rate of the tungsten film is equal to or more than four times a polishing rate of the silicon nitride film.

7. The method of claim 5, wherein the polishing target comprises a tungsten film and a silicon nitride film.

8. The method of claim 7, wherein an alkyl sulfate moiety or an alkyl ether sulfate moiety included in the alkanolamine salt (C) has an alkyl chain having 8 to 20 carbon atoms.

9. The method of claim 7, wherein a content of the alkanolamine salt (C) is 0.01 to 0.6 mass %.

10. The method of claim 7, wherein a content of the anionic water-soluble polymer (B) is 0.005 to 0.15 mass %.

11. The method claim 7, wherein the polishing target consists of a tungsten film and a silicon nitride film.

12. The method of claim 11, wherein a polishing rate of the tungsten film is equal to or more than four times a polishing rate of the silicon nitride film.
